(19) United States
(12) Patent Application Publication
(10) Pub. No.: US 2024/0192460 A1
(43) Pub. Date: Jun. 13, 2024

(54) FIELD INSTALLABLE HARDENED FIBER OPTIC CONNECTOR WITH IMPROVED SEALING AND TOOLLESS INSTALLATION

(71) Applicant: PPC BROADBAND, INC., East Syracuse, NY (US)

(72) Inventors: Abilash NEVILLE, Ernakulam (KL) (IN); Navaneeth JAYACHANDRAN, Ernakulam (KL) (IN); Noah MONTENA, Syracuse, NY (US)

(73) Assignee: PPC BROADBAND, INC., East Syracuse, NY (US)

(21) Appl. No.: 18/534,228

(22) Filed: Dec. 8, 2023

Related U.S. Application Data
(60) Provisional application No. 63/528,718, filed on Jul. 25, 2023.

(30) Foreign Application Priority Data
Dec. 9, 2022 (IN) 22221071161

(51) Int. Cl. G02B 6/44

(52) U.S. Cl. CPC G02B 6/44775; G02B 6/44765

(57) ABSTRACT

A seal assembly for a field installable hardened fiber optic connector that may be configured to provide improved sealing and strain relief with a fiber optic cable includes: a pusher portion configured to transfer movement of a tightening portion; and a sealing portion configured to receive the transferred movement of the pusher portion. An engagement of the pusher portion with a shroud portion may limit rotation of the pusher portion relative to the shroud portion. The sealing portion may be configured to compress to form a seal around the fiber optic cable. Tightening of a tightening portion may compress the sealing portion onto a fiber optic cable to form a seal around the fiber optic cable and resist axial movement of the fiber optic cable relative to the sealing portion so as to provide enhanced weathertight sealing and strain relief between a shroud and the fiber optic cable.

### CROSS-REFERENCE TO RELATED APPLICATION

This application claims the benefit of India Provisional Patent Application No. 202221071161, filed Dec. 9, 2022, and U.S. Provisional Application No. 63/528,718 filed Jul. 25, 2023, which are currently pending, the disclosures of which are hereby incorporated by reference herein in their entirety.

### BACKGROUND

The present disclosure is directed to a fiber optic connector with improved sealing and, more particularly, to a field installable hardened fiber optic connector (HFOC) with improved weathertight sealing and toolless installation.

Fiber optical communication systems typically use a network of fiber optic cables to transmit large volumes of data. Typical fiber optical connectors include a ferrule that supports an end portion of an optical fiber. When two fiber optical connectors are interconnected, end faces of the ferrules, on each connector, directly oppose one another. Thus, the optical fibers, which are supported by each ferrule, are also directly opposed to each other. Furthermore, springs in each connector bias the optical fibers towards each other when the connectors are in this interconnected state. An optical signal can then be transmitted from one optical fiber to the other optical fiber.

Conventionally, hardened fiber optic connectors are factory fitted on one end of a fiber optic cable, and the sealing between the hardened fiber optic connector and the fiber optic cable is achieved by using epoxy resins and heat shrink boots. As a result, only one end of the cable assembly (i.e., the nonterminated end) can be routed through small ducts or holes.

It may be desirable to provide a hardened fiber optic connector that is field installable and provides improved weathertight sealing so that both ends of a fiber optic cable can be routed through small ducts or holes and the ends can be terminated with a hardened fiber optic connector after such routing. It may also be desirable to provide a hardened fiber optic connector that is field installable, provides improved sealing, and can be installed by hand (i.e., without a tool).

### SUMMARY

Particular embodiments provide a seal assembly for a field installable hardened fiber optic connector structurally configured to provide improved sealing and strain relief with a fiber optic cable including: a shroud structurally configured to receive a terminated end of a fiber optic cable; a nut structurally configured to be coupled with an end of the shroud; a pusher structurally configured to be received by the nut and the shroud; and a sealing portion structurally configured to be received by the pusher and the shroud. The nut may be structurally configured to threadedly engage the shroud such that tightening of the nut may compress the sealing portion onto a fiber optic cable received in the shroud to form a seal around the fiber optic cable and resist axial movement of the fiber optic cable relative to the sealing portion so as to provide enhanced weathertight sealing and strain relief between the shroud and the fiber optic cable.

According to various embodiments, the nut may be structurally configured to include an engaging portion that is structurally configured to engage the pusher such that the pusher is coupled to the nut.

According to various embodiments, the pusher may be structurally configured to engage the shroud.

According to various embodiments, the engagement of the pusher with the shroud may limit rotation of the pusher relative to the shroud.

According to various embodiments, the nut may comprise a single piece monolithic construction that includes the engagement portion.

According to various embodiments, the engagement portion may comprise a structure that is separate from a remainder of the nut.

According to various embodiments, the engagement portion may be structurally configured to be received in the pusher.

According to various embodiments, the sealing portion may be structurally configured to deform in response to movement of the nut relative to the shroud.

According to various embodiments, the sealing portion may be structurally configured to have different radial cross-sections along an axial direction of the sealing portion.

According to various embodiments, a first end of the sealing portion that is received by the pusher may have a smaller radial diameter and a second end of the sealing portion that is receive by the shroud.

According to various embodiments, the sealing portion may be a grommet.

According to various embodiments, a hardened fiber optic connector may include: the seal assembly; a ferrule that may be structurally configured to terminate a fiber of the fiber optic cable; a holder that may be structurally configured to receive the ferrule and to be received in the shroud; and a shell that may be structurally configured to receive the shroud and to be coupled with a hardened fiber optic connector receptacle.

According to various embodiments, the hardened fiber optic connector may further include an outer boot structurally configured to be coupled with the shroud and/or the shell.

Particular embodiments provide a seal assembly for a field installable hardened fiber optic connector structurally configured to provide improved sealing and strain relief with a fiber optic cable including: a shroud portion structurally configured to receive a fiber optic cable; a tightening portion structurally configured to be coupled with the shroud portion; a pusher portion structurally configured to transfer movement of the tightening portion; and a sealing portion structurally configured to receive the transferred movement of the pusher portion. The tightening portion may be structurally configured to threadedly engage the shroud such that tightening of the tightening portion may compress the sealing portion onto a fiber optic cable received in the shroud to form a seal around the fiber optic cable and resist axial movement of the fiber optic cable relative to the sealing portion so as to provide enhanced weathertight sealing and strain relief between the shroud and the fiber optic cable.

According to various embodiments, an engagement of the pusher portion with the shroud portion limits rotation of the pusher portion relative to the shroud portion.

According to various embodiments, the tightening portion may be structurally configured to be coupled with an end of the shroud portion.

According to various embodiments, the pusher portion may be structurally configured to be received by the tightening portion and the shroud portion.

According to various embodiments, the sealing portion may be structurally configured to be received by the pusher portion and the shroud portion.

According to various embodiments, the tightening portion may be structurally configured to include an engaging portion that may be structurally configured to engage the pusher portion such that the pusher portion is coupled to the tightening portion.

According to various embodiments, the tightening portion may comprise a single piece monolithic construction that includes the engagement portion.

According to various embodiments, the tightening portion may be structurally configured to threadedly engage the shroud portion.

According to various embodiments, the compression of the sealing portion on the fiber optic cable may resist axial movement of the fiber optic cable relative to the sealing portion.

Particular embodiments provide a seal assembly for a field installable hardened fiber optic connector structurally configured to provide improved sealing and strain relief with a fiber optic cable including: a pusher portion structurally configured to transfer movement of a tightening portion; and a sealing portion structurally configured to receive the transferred movement of the pusher portion. The tightening of a tightening portion may compress the sealing portion onto a fiber optic cable to form a seal around the fiber optic cable and resist axial movement of the fiber optic cable relative to the sealing portion so as to provide enhanced weathertight sealing and strain relief between a shroud and the fiber optic cable.

According to various embodiments, an engagement of the pusher portion with a shroud portion may limit rotation of the pusher portion relative to the shroud portion.

According to various embodiments, the sealing portion may be structurally configured to compress to form a seal around the fiber optic cable.

According to various embodiments, the seal assembly may further comprise a shroud portion that may be structurally configured to receive the fiber optic cable.

According to various embodiments, the seal assembly may further comprise a tightening portion that may be structurally configured to be coupled with the shroud portion.

According to various embodiments, an engagement of the tightening portion with the shroud portion may be structurally configured to compress the sealing portion to form the seal around the fiber optic cable.

According to various embodiments, the tightening portion may be structurally configured to be coupled with an end of the shroud portion.

According to various embodiments, the pusher portion may be structurally configured to be received by the tightening portion and the shroud portion.

### BRIEF DESCRIPTION OF THE DRAWINGS

Features and advantages of the present disclosure are described in, and will be apparent from, the following Brief Description of the Drawings and Detailed Description.

FIG. 1 is a side cross-sectional view of a first embodiment of an exemplary seal assembly for a hardened fiber optic connector in an unsealed configuration in accordance with various aspects of the disclosure;

FIG. 2 is the side cross-sectional view of the exemplary seal assembly of FIG. 1 in a sealed configuration;

FIG. 3 is a perspective view of the exemplary seal assembly of FIG. 2;

FIG. 4 is a side cross-sectional view of a second embodiment of an exemplary seal assembly for a hardened fiber optic connector in an unsealed configuration in accordance with various aspects of the disclosure;

FIG. 5 is the side cross-sectional view of the exemplary seal assembly of FIG. 4 in a sealed configuration;

FIG. 6 is a perspective view of the exemplary seal assembly of FIG. 5;

FIG. 7 is a side cross-sectional view of a third embodiment of an exemplary seal assembly for a hardened fiber optic connector in an unsealed configuration in accordance with various aspects of the disclosure;

FIG. 8 is an enlarged perspective view of a portion of the exemplary seal assembly of FIG. 7;

FIG. 9 is the side cross-sectional view of the exemplary seal assembly of FIG. 7 in a sealed configuration;

FIG. 10 is an enlarged perspective view of a portion of the exemplary seal assembly of FIG. 9;

FIG. 11 is a side cross-sectional view of a hardened fiber optic connector that includes the exemplary seal assembly of FIG. 7 in an unsealed configuration;

FIG. 12 is a perspective view of the hardened fiber optic connector of FIG. 11;

FIG. 13 is a side cross-sectional view of a hardened fiber optic connector that includes the exemplary seal assembly of FIG. 9 in a sealed configuration;

FIG. 14 is a side cross-sectional view of a hardened fiber optic connector that includes a fourth embodiment of an exemplary seal assembly in an unsealed configuration in accordance with various aspects of the disclosure;

FIG. 15 is a perspective view of the hardened fiber optic connector of FIG. 14;

FIG. 16 is a side cross-sectional view of the hardened fiber optic connector of FIG. 14 in a sealed configuration;

FIG. 17 is a perspective view of the hardened fiber optic connector of FIG. 16;

FIG. 18 is a side cross-sectional view of a fifth embodiment of an exemplary seal assembly for a hardened fiber optic connector in an unsealed configuration in accordance with various aspects of the disclosure;

FIG. 19 is the side cross-sectional view of the exemplary seal assembly of FIG. 18 in a sealed configuration;

FIG. 20 is a perspective view of the exemplary seal assembly of FIG. 19.

FIG. 21 is a side cross-sectional view of a sixth embodiment of an exemplary seal assembly for a hardened fiber optic connector in an unsealed configuration in accordance with various aspects of the disclosure;

FIG. 22 is a side cross-sectional view of the exemplary seal assembly of FIG. 21 in a sealed configuration;

FIG. 23 is a perspective view of the exemplary seal assembly of FIG. 21 in an unsealed configuration;

FIG. 24 is a perspective view of the exemplary seal assembly of FIG. 21 in a sealed configuration;

FIG. 25 is a side cross-sectional partial view of the exemplary seal assembly of FIG. 21 in an unsealed configuration;

FIG. 26 is a side cross-sectional partial view of the exemplary seal assembly of FIG. 25 in a sealed configuration; and

FIG. 27 is a perspective view of an exemplary pusher of the exemplary seal assembly of FIG. 21.

### DETAILED DESCRIPTION OF EMBODIMENTS

Embodiments provide a seal assembly having a nut that is structurally configured to threadedly engage a shroud such that tightening of the nut compresses a sealing portion onto a fiber optic cable received in the shroud to form a seal around the fiber optic cable and resist axial movement of the fiber optic cable relative to the sealing portion so as to provide enhanced weathertight sealing and strain relief between the shroud and the fiber optic cable.

Throughout the description, like reference numerals will refer to like parts in the various drawing figures. As a preface to the detailed description, it should be noted that, as used in this specification and the appended claims, the singular forms “a,” “an,” and “the” include plural referents, unless the context clearly dictates otherwise.

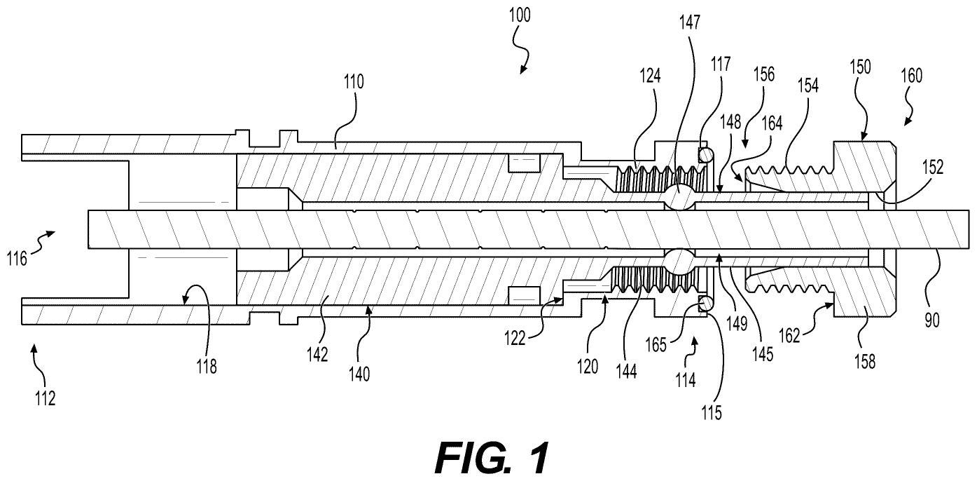

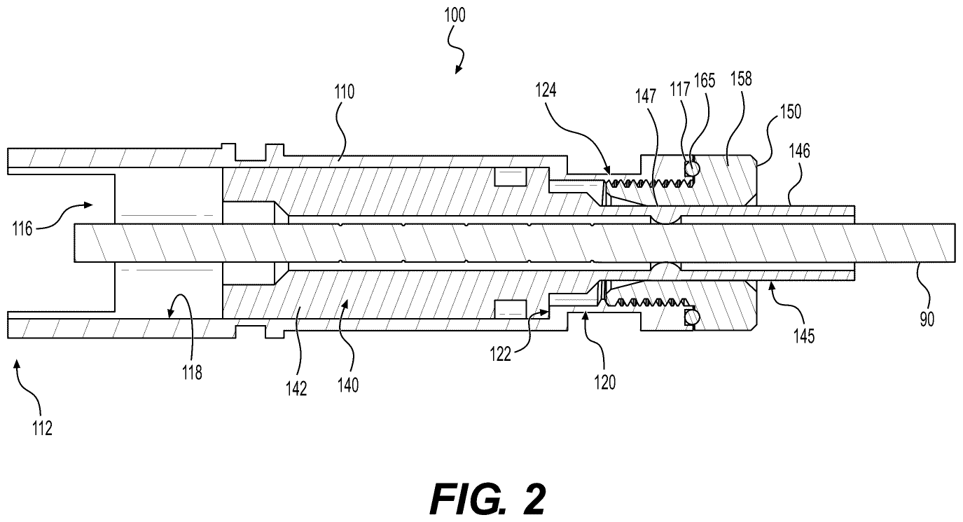

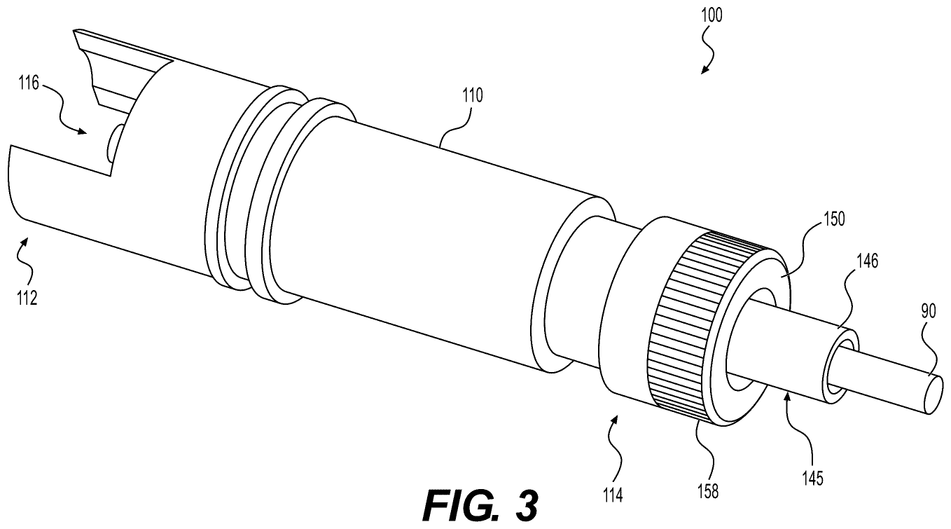

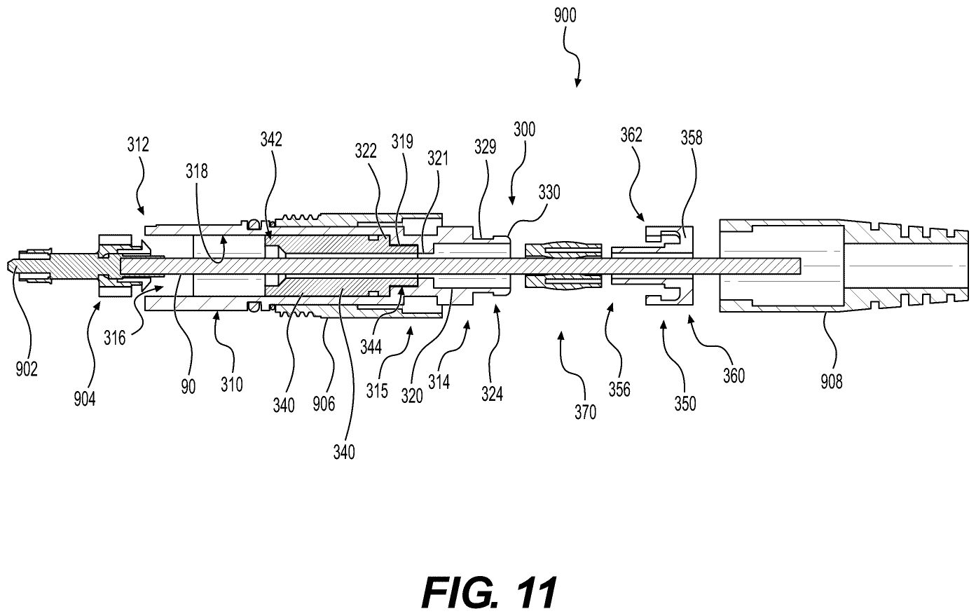

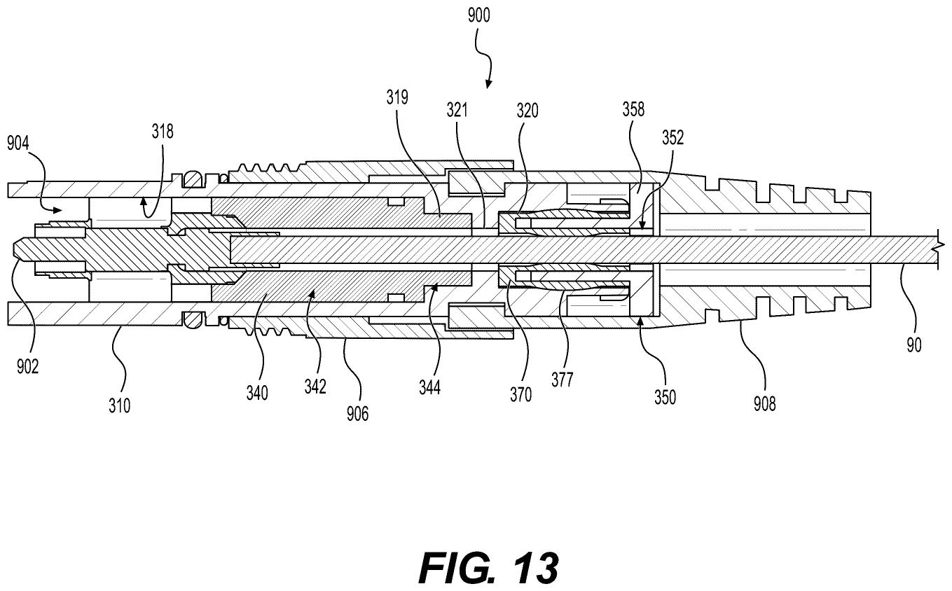

FIGS. 1-3 illustrate a first embodiment of an exemplary seal assembly 100 for a hardened fiber optic connector (HFOC) in accordance with various aspects of the disclosure. As shown in FIGS. 1 and 2, the seal assembly 100 includes a shroud or shroud portion 110 (also referred to as a shell or housing) of a hardened fiber optic connector, a biasing member, resilient member, or boot 140 of the hardened fiber optic connector, and a coupler or tightening portion or nut 150. Additional features of an exemplary hardened fiber optic connector that incorporates the seal assembly 100 are described below in connection with FIGS. 11-17.

The shroud 110 includes a first end or forward end 112 and a second end or rear end 114. The shroud 110 includes an opening 116 at the first end 112 to a first receiving portion or bore 118. The second end 114 of the shroud 110 includes a second receiving portion or bore 120 having a smaller inside diameter than the first receiving portion 118 such that a forward facing surface 122 is defined at the transition from the first receiving portion 118 to the second receiving portion 120. The second receiving portion 120 may include a threaded portion 124, for example, a threaded inner surface, at the second end 114 of the shroud 110.

The boot 140 comprises a first portion or forward portion 142 that is configured to be slidingly received in the first receiving portion 118 of the shroud 110 and a second portion or rear portion 144 that is configured to be received in the second receiving portion 120 of the shroud 110. The first portion 142 of the boot 140 has an outside diameter that is greater than the inside diameter of the second receiving portion 120 such that the forward facing surface 122 of the shroud 110 acts as a stop that limits the distance that the first portion 142, and thus the boot 140, can be inserted into the shroud 110 via the opening 116. In some aspects, the first receiving portion 118 of the shroud 110 is configured to receive the first portion 142 of the boot 140 in an interference fit relationship. In other aspects, the first receiving portion 118 of the shroud 110 is configured to receive the first portion 142 of the boot 140 is a loose fit relationship.

The second portion 144 of the boot 140 comprises a tubular or cylindrical portion 145 that extends through the threaded portion 124 of the shroud 110 and out the second end 114 of the shroud 110. The tubular portion 145 is configured to slidingly receive a fiber optic cable 90.

The nut 150 includes a receiving portion or through bore 152 configured to slidingly receive a fiber optic cable therethrough, a threaded portion 154 for example, a threaded outer surface, at a first end 156 of the nut 150, and a flange portion 158 at a second end 160 of the nut 150. The flange portion 158 has a larger outside diameter than the threaded portion 154 such that a forward facing surface 162 is defined at the transition from the threaded portion 154 to the flange portion 158. The receiving portion 152 of the nut 150 is configured to slidingly receive the tubular portion 145 of the boot 140, for example, in an interference fit or a loose fit relationship.

The tubular portion 145 of the boot 140 that extends out the second end 114 of the shroud 110, for example end portion 146, has an outside diameter that is configured to be received in the receiving portion 152 of the nut 150. The tubular portion 145 includes an enlarged portion or annular projection 147 that extends radially outward from an outer surface 148 of the tubular portion 146 and radially inward from an inner surface 149 of the tubular portion 146. An outside diameter of the enlarged portion 147 is greater than an inside diameter of the receiving portion 152 of the nut 150 such that the enlarged portion 147 cannot be slidingly received in the receiving portion 152 of the nut 150. The boot 140, including the enlarged portion 147, comprises a flexible structure that is configured to be compressed and to provide a biasing force against such compression. For example, the boot 140 may be formed from a flexible material such as KRAYTON.

Referring to FIG. 2, to provide a weathertight sealed connection between the boot 140 and a fiber optic cable 90 received by the boot 140, the nut 150 is threadedly coupled with the shroud 110. For example, the threaded portion 154 of the nut 150 is coupled with the threaded portion 124 of the shroud 110. As the nut 150 is threadedly coupled with the shroud 110, the receiving portion 152 of the nut 150 engages the enlarged portion 147 of the boot 140. As the nut 150 is threaded further into the shroud 110, the receiving portion 152 of the nut 150 is configured to compress the enlarged portion 147 radially inward against the fiber optic cable 90 to provide a weathertight seal between an inner surface of the nut 150 and an outer surface of the boot 140 and between an inner surface of the boot 140 and an outer surface of the fiber optic cable 90. The nut 150 is configured to be threadedly coupled with the shroud 110 to the tightened configuration shown in FIG. 2 where the forward facing surface 162 of the nut 150 engages a rearmost surface 111 of the shroud 110. In some aspects, the nut 150 may have an opening 164 at the first end 156 that tapers toward the second end 160 to facilitate the receiving portion 152 of the nut 150 to receive the enlarged portion 147 of the boot 140.

As illustrated, the second end 114 of the shroud 110 includes a rearward facing surface 115 having a groove 117 configured to receive a biasing member or sealing member 165. The groove 117 is sized such that the biasing member 165 extends beyond the second end 114 of the shroud 110 in a rest configuration. When the nut 150 is threadedly coupled with the shroud 110 to the tightened configuration shown in FIG. 2, the forward facing surface 162 of the nut 150 is configured to compress the biasing member 165 to weathertight seal the interface between the rearward facing surface 115 of the shroud 110 and the forward facing surface 162 of the nut 150.

The flange portion 158 of the nut 150 may include a knurled outer surface to facilitate hand tightening (i.e., without the use of a tool) of the nut 150 to the shroud 110. In some aspects, the flange portion 158 of the nut 150 may comprise a hexagonal surface to facilitate hand tightening while also accommodating tightening via a tool, for example, a wrench.

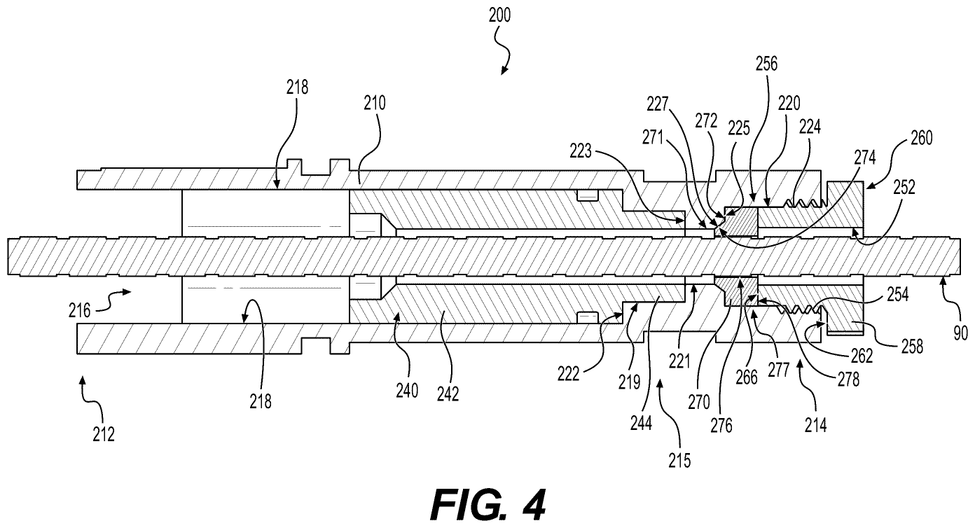

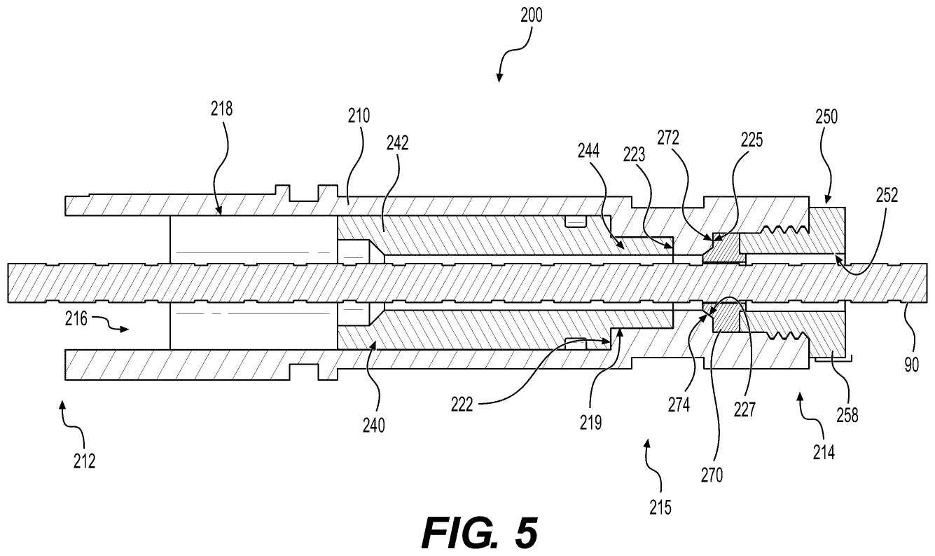

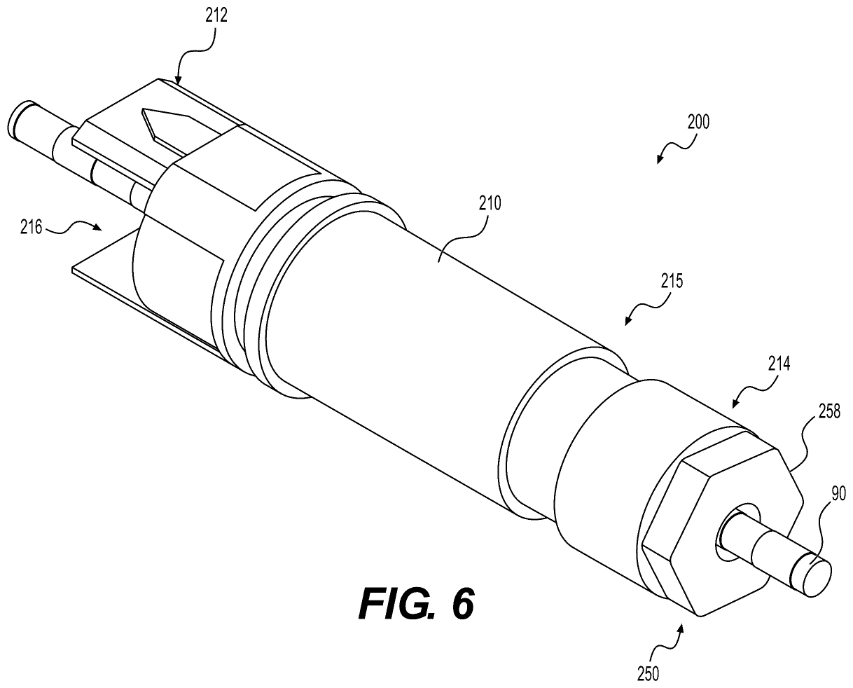

FIGS. 4-6 illustrate a second embodiment of an exemplary seal assembly 200 for a hardened fiber optic connector (HFOC) in accordance with various aspects of the disclosure. As shown in FIGS. 4 and 5, the seal assembly 200 includes a shroud or shroud portion 210 (also referred to as a shell or housing) of a hardened fiber optic connector, a resilient member or boot 240 of the hardened fiber optic connector, a coupler or tightening portion or nut 250, and a biasing member or sealing portion or grommet 270. Additional features of an exemplary hardened fiber optic connector that incorporates the seal assembly 200 are described below in connection with FIGS. 11-17.

The shroud 210 includes a first end or forward end 212 and a second end or rear end 214. The shroud 210 includes an opening 216 at the first end 212 to a first receiving portion or bore 218. The second end 214 of the shroud 210 includes a second receiving portion or bore 220 that includes a threaded portion 224, for example, a threaded inner surface, at the second end 214 of the shroud 210. The second receiving portion 220 is configured to receive the grommet 270 therein, for example in an interference fit relationship or a loose fit relationship. The grommet 270 includes a receiving portion or through bore 276 configured to receive a fiber optic cable there through. The grommet 270 comprises a flexible structure that is configured to be compressed and to provide a biasing force against such compression. For example, the grommet 270 may be formed from a flexible material such as KRAYTON.

A middle portion 215 of the shroud 210 between the first end 212 and the second end 214 includes a third receiving portion or third bore 219 adjacent the first receiving portion 218 and having a smaller inside diameter than the first receiving portion 218 such that a forward facing surface 222 is defined at the transition from the first receiving portion 218 to the third receiving portion 219. The middle portion 215 further includes a fourth receiving portion 221 having a smaller inside diameter than the third receiving portion 219 and the second receiving portion 220 such that a forward facing surface 223 is defined at the transition from the third receiving portion 219 to the fourth receiving portion 221 and a rearward facing surface 225 is defined at the transition from the second receiving portion 220 to the fourth receiving portion 221. The rearward facing surface 225 transitions from the second receiving portion 220 to the fourth receiving portion 221 via a tapered portion 227. The grommet 270 includes a front end or forward end 271 having a forward facing surface 272 configured to face the rearward facing surface 225 and a tapered forward surface 274 configured to face the tapered portion 227. The grommet 270 includes a second end or rear end 277 having a rearward facing surface 278.

The boot 240 comprises first portion or forward portion 242 that is configured to be slidingly received in the first receiving portion 218 of the shroud 210 and a second portion or rear portion 244 that is configured to be received in the third receiving portion 219 of the shroud 210. The first portion 242 of the boot 240 has an outside diameter that is greater than the inside diameter of the third receiving portion 219, and the second portion 244 of the boot 240 has an outside diameter that is greater than the inside diameter of the fourth receiving portion 221, such that the forward facing surface 222 of the shroud 210 and/or the forward facing surface 223 of the shroud 210 acts as a stop that limits the distance that the boot 240 can be inserted into the shroud 210 via the opening 216. In some aspects, the first receiving portion 218 of the shroud 210 is configured to receive the first portion 242 of the boot 240 in an interference fit relationship. In other aspects, the first receiving portion 218 of the shroud 210 is configured to receive the first portion 242 of the boot 240 in a loose fit relationship. In some aspects, the third receiving portion 219 of the shroud 210 is configured to receive the second portion 244 of the boot 240 in an interference fit relationship. In other aspects, the third receiving portion 219 of the shroud 210 is configured to receive the second portion 244 of the boot 240 in a loose fit relationship. The boot 240 comprises a receiving portion or through bore 245 that is configured to slidingly receive a fiber optic cable 90 therethrough.

The nut 250 includes a receiving portion or through bore 252 configured to slidingly receive a fiber optic cable 90 therethrough, a threaded portion 254 for example, a threaded outer surface, at a first end 256 of the nut 250, and a flange portion 258 at a second end 260 of the nut 250. The flange portion 258 has a larger outside diameter than the threaded portion 254 such that a forward facing surface 262 is defined at the transition from the threaded portion 254 to the flange portion 258. The nut 250 includes a forward facing surface 266 at the first end 256.

Referring to FIG. 5, to provide a weathertight sealed connection between the grommet 270 and a fiber optic cable 90 received by the grommet 270, the nut 250 is threadedly coupled with the shroud 210. For example, the threaded portion 254 of the nut 250 is coupled with the threaded portion 224 of the shroud 210. As the nut 250 is threadedly coupled with the shroud 210, the forward facing surface 266 at the first end 256 of the nut 250 engages the rearward facing surface 278 of the grommet 270. As the nut 250 is threaded further into the shroud 210, the forward facing surface 266 of the nut 250 is configured to compress, for example, axially compress, the grommet 270 against the rearward facing surface 225 of the shroud 210 such that the grommet 270 is compressed into the fourth receiving portion 221 of the shroud 210 via the tapered portion 227 and is radially compressed onto the fiber optic cable 90. The nut 250 is configured to be threadedly coupled with the shroud 210 to the tightened configuration shown in FIG. 5 where a forward facing surface 262 of the nut 250 engages a rearmost surface 211 of the shroud 210.

The flange portion 258 of the nut 250 may include a hexagonal outer surface to facilitate hand tightening while also accommodating tightening via a tool, for example, a wrench. In some aspects, the flange portion 258 of the nut 250 may comprise a knurled outer surface to facilitate hand tightening (i.e., without the use of a tool) of the nut 250 to shroud 210.

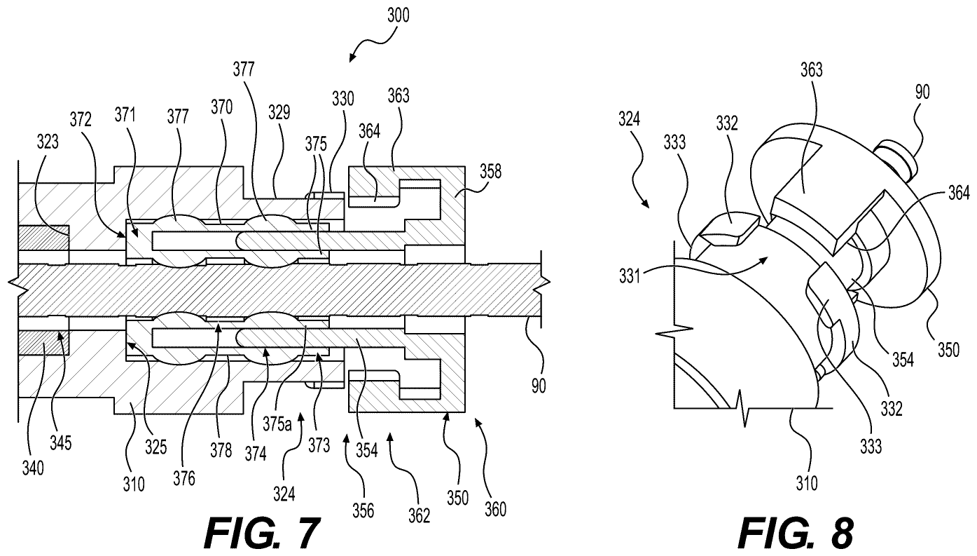

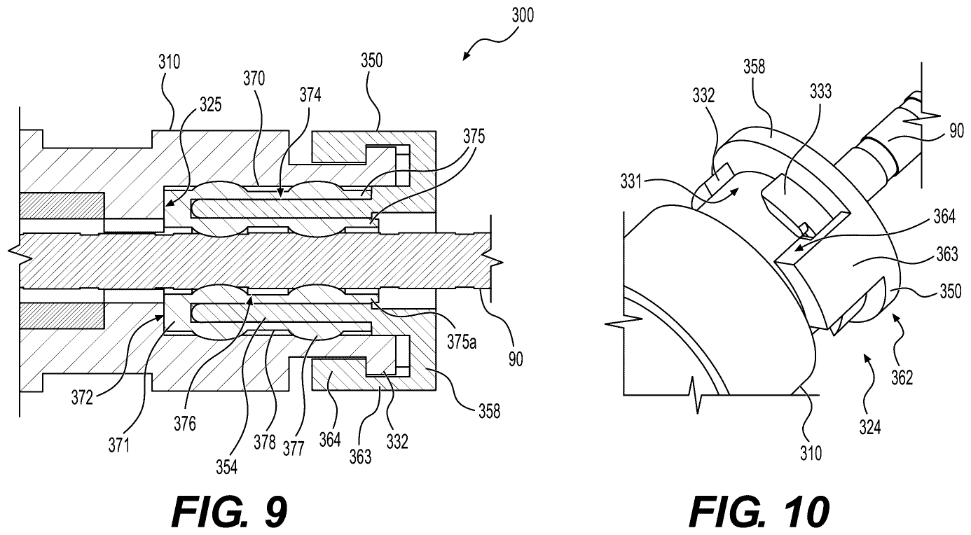

FIGS. 7-13 illustrate a third embodiment of an exemplary seal assembly 300 for a hardened fiber optic connector (HFOC) in accordance with various aspects of the disclosure. As shown in FIGS. 7 and 9, the seal assembly 300 includes a shroud or shroud portion 310 (also referred to as a shell or housing) of a hardened fiber optic connector 900, a resilient member or boot 340 of the hardened fiber optic connector, a coupler or tightening portion or nut 350, and a biasing member or sealing portion or grommet 370.

Referring to FIGS. 11-13, the exemplary hardened fiber optic connector 900 includes a ferrule 902 that is configured to terminate a fiber of a fiber optic cable 90, a carrier or holder 904 that is configured to receive the ferrule 902 and that is configured to be received in the shroud 310, an outer housing or shell 906 that is configured to receive the shroud 310 and that is configured to be coupled with an HFOC receptacle, and an outer boot 908 configured to be coupled with the shroud 310 and/or the outer housing 906.

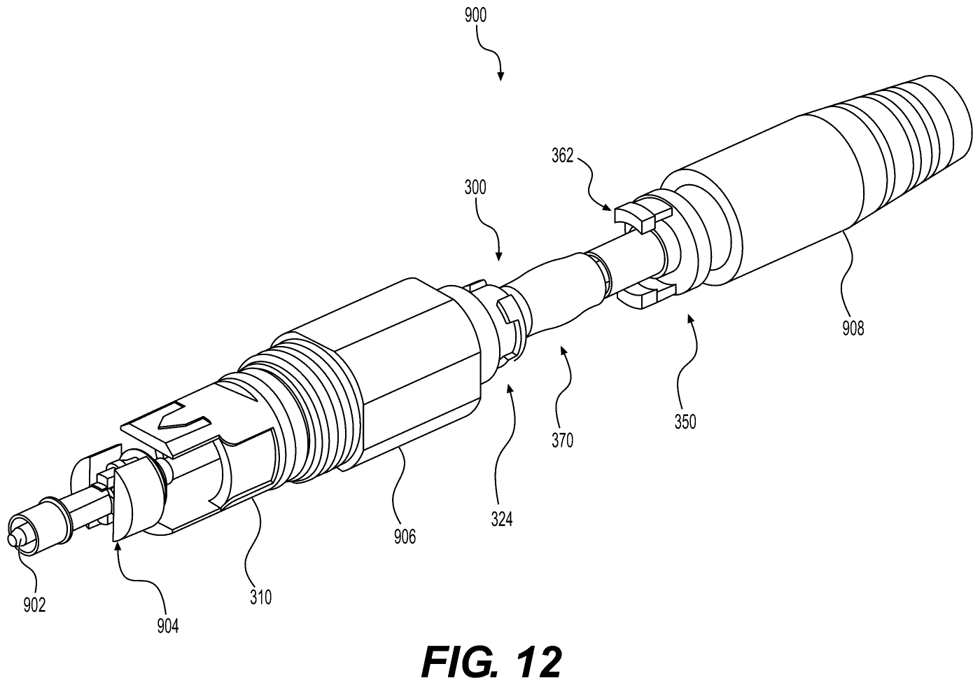

As best shown in FIGS. 11 and 12, the shroud 310 includes a first end or forward end 312 and a second end or rear end 314. The shroud 310 includes an opening 316 at the first end 312 to a first receiving portion or bore 318. The second end 314 of the shroud 310 includes a second receiving portion or bore 320. The second receiving portion 320 is configured to receive the grommet 370 therein, for example in an interference fit relationship or a loose fit relationship. The grommet 370 includes a receiving portion or through bore 376 configured to receive a fiber optic cable there through. The grommet 370 comprises a flexible structure that is configured to be compressed and to provide a biasing force against such compression. For example, the grommet 370 may be formed from a flexible material such as KRAYTON. The second end 314 of the shroud 310 includes a receiving portion or keyed portion 324, for example, on an outer surface 329 of the shroud 310.

The receiving portion 324 may include a plurality of projections 330 extending from the outer surface 329 of the shroud 310 and spaced apart in a circumferential direction to define passages or keyways 331. Each of the projections 330 comprises a first portion 332 having a first length in an axial direction extending from the first end 312 to the second end 314 of the shroud 310 and a second portion 333 having a second length in the axial direction that is greater than the first dimension.

A middle portion 315 of the shroud 310 between the first end 312 and the second end 314 includes a third receiving portion or third bore 319 adjacent the first receiving portion 318 and having a smaller inside diameter than the first receiving portion 318 such that a forward facing surface 322 is defined at the transition from the first receiving portion 318 to the third receiving portion 319. The middle portion 315 further includes a fourth receiving portion 321 having a smaller inside diameter than the third receiving portion 319 and the second receiving portion 320 such that a forward facing surface 323 is defined at the transition from the third receiving portion 319 to the fourth receiving portion 321 and a rearward facing surface 325 is defined at the transition from the second receiving portion 320 to the fourth receiving portion 321.

The boot 340 comprises first portion or forward portion 342 that is configured to be slidingly received in the first receiving portion 318 of the shroud 310 and a second portion or rear portion 344 that is configured to be received in the third receiving portion 319 of the shroud 310. The first portion 342 of the boot 340 has an outside diameter that is greater than the inside diameter of the third receiving portion 319, and the second portion 344 of the boot 340 has an outside diameter that is greater than the inside diameter of the fourth receiving portion 321, such that the forward facing surface 322 of the shroud 310 and/or the forward facing surface 323 of the shroud 310 acts as a stop that limits the distance that the boot 340 can be inserted into the shroud 310 via the opening 316. In some aspects, the first receiving portion 318 of the shroud 310 is configured to receive the first portion 342 of the boot 340 in an interference fit relationship. In other aspects, the first receiving portion 318 of the shroud 310 is configured to receive the first portion 342 of the boot 340 in a loose fit relationship. In some aspects, the third receiving portion 319 of the shroud 310 is configured to receive the second portion 344 of the boot 340 in an interference fit relationship. In other aspects, the third receiving portion 319 of the shroud 310 is configured to receive the second portion 344 of the boot 340 in a loose fit relationship. The boot 340 comprises a receiving portion or through bore 345 that is configured to slidingly receive a fiber optic cable 90 therethrough.

The nut 350 includes a receiving portion or through bore 352 configured to slidingly receive a fiber optic cable 90 therethrough, an engagement portion 354 for example, a cylindrical wall, that extends from a first end 356 of the nut 350 to a second end 360 of the nut 350, and a flange portion 358 at the second end of the nut. The nut 350 includes an engagement feature 362, for example, axially extending keys, extending from the flange portion 358 and configured to be coupled with the receiving portion 324 of the shroud 310. In some aspects, the engagement feature 362 may comprise a plurality of axially extending tabs 363 with a lip 364 extending radially inward at the free end of the tab 363. The engagement feature 362 is configured to be slidingly received through the passages 331 of the receiving portion 324 so that the engagement feature 362, for example, the lips 364, extends beyond the receiving portion 324 and can be rotated relative to the receiving portion 324. The second portion 333 of the receiving portion 324 is configured to limit the circumferential rotation of the nut 350 relative to the shroud 310. For example, the receiving portion 324 and the engagement feature 362 may be configured to limit the rotation of the nut 350 relative to the shroud 310 to 90°, or a quarter turn.

The grommet 370 includes a first end or forward end 371 having a forward facing surface 372 configured to face the rearward facing surface 325 of the shroud 310 and a second end or rear end 373. The grommet 370 includes a receiving portion 374, for example, an annular opening, between a pair of spaced apart structures 375, for example, concentric cylindrical walls that are spaced apart in a radial direction. The through bore 376 extends through the inner one 375a of the spaced apart walls 375. The receiving portion 374 is closed at the first end 371 of the grommet 370. The receiving portion 374 comprises a radial length that is less than a radial length of the engagement portion 354 of the nut 350. The grommet 370 includes an enlarged portion or annular projection 377 that extends radially outward from an outer surface 378 of the grommet 370 and radially inward from an inner surface 379 of the grommet 370.

Referring to FIGS. 9, 10, and 12, to provide a weathertight sealed connection between the grommet 370 and a fiber optic cable 90 received by the grommet 370, the nut 350 is moved relative to the shroud 310 such that the engagement portion 354 moves axially into the receiving portion 374 of the grommet. As the nut 350 is moved further axially relative to the shroud 310, the engagement feature 362 of the nut 350 is inserted through the passages 331 of the receiving portion 324 of the shroud until the engagement feature 362, for example, the lips 364, extends beyond the receiving portion 324 and can be rotated relative to the receiving portion 324. The nut 350 is rotated relative to the shroud 310, for example, by 90°, or a quarter turn, until the engagement feature 362 engages the receiving portion 324, for example, the second portion 333 of the receiving portion 324. is configured to limit the circumferential rotation of the nut 350 relative to the shroud 310. For example, the receiving portion 324 and the engagement feature 362 may be configured to limit the rotation of the nut 350 relative to the shroud 310 to 90°, or a quarter turn, such that the receiving portion 324 is configured to engage the engagement feature 362 to prevent the nut 350 from being biased away from the shroud by the compressed grommet 370.

Because the receiving portion 374 comprises a radial length that is less than a radial length of the engagement portion 354 of the nut 350, when the engagement portion 354 is inserted into the receiving portion 374, the engagement portion urges the receiving portion 374 radially inward and radially outward such that the enlarged portion 377 of the grommet 370 sealingly engages an outer surface of the fiber optic cable 90 and an inner surface of the second receiving portion 320 of the shroud 310.

The flange portion 358 of the nut 350 may include a knurled outer surface to facilitate hand tightening (i.e., without the use of a tool) of the nut 350 to the shroud 310. In some aspects, the flange portion 358 of the nut 350 may comprise a hexagonal surface to facilitate hand tightening while also accommodating tightening via a tool, for example, a wrench.

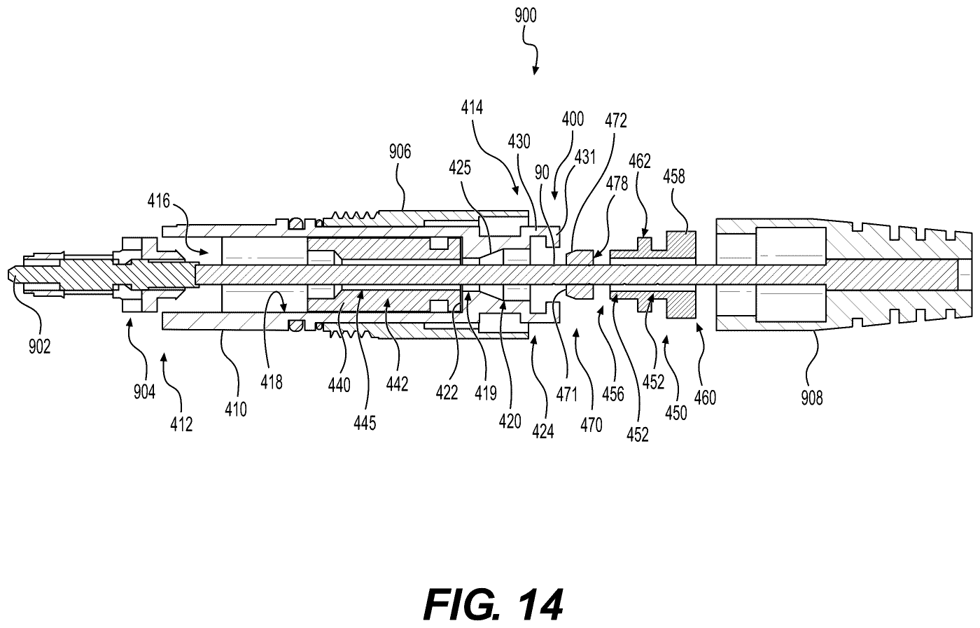

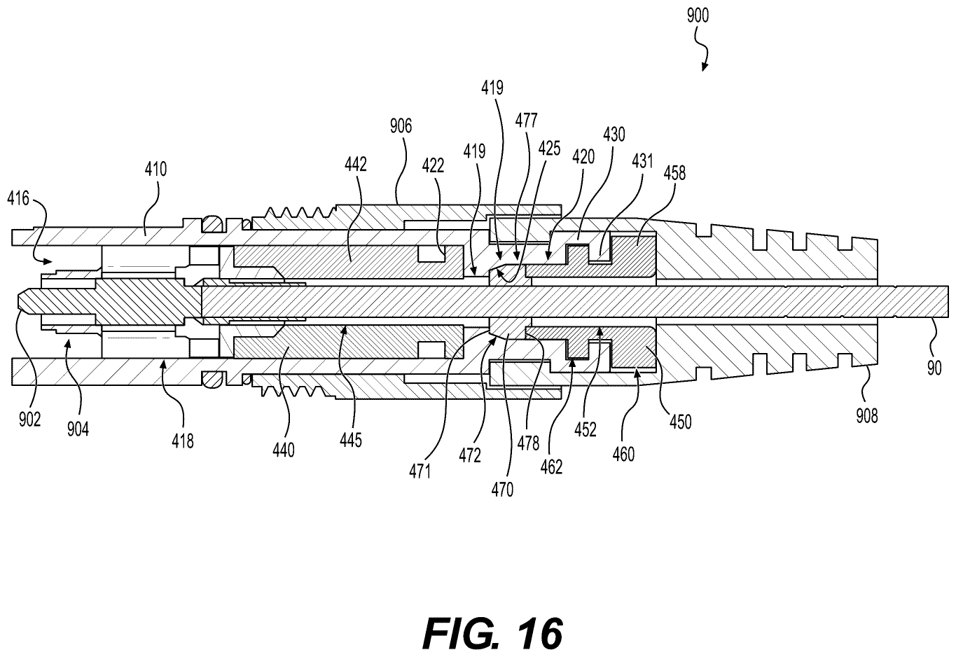

FIGS. 14-17 illustrate a fourth embodiment of an exemplary seal assembly 400 for a hardened fiber optic connector (HFOC) in accordance with various aspects of the disclosure. As shown in FIGS. 14 and 16, the seal assembly 400 includes a shroud or shroud portion 410 (also referred to as a shell or housing) of a hardened fiber optic connector 900, a resilient member or boot 440 of the hardened fiber optic connector, a coupler or tightening portion or nut 450, and a biasing member or sealing portion or grommet 470.

The exemplary hardened fiber optic connector 900 includes a ferrule 902 that is configured to terminate a fiber of a fiber optic cable 90, a carrier or holder 904 that is configured to receive the ferrule 902 and that is configured to be received in the shroud 410, an outer housing or shell 906 that is configured to receive the shroud 410 and that is configured to be coupled with an HFOC receptacle, and an outer boot 908 configured to be coupled with the shroud 410 and/or the outer housing 906.

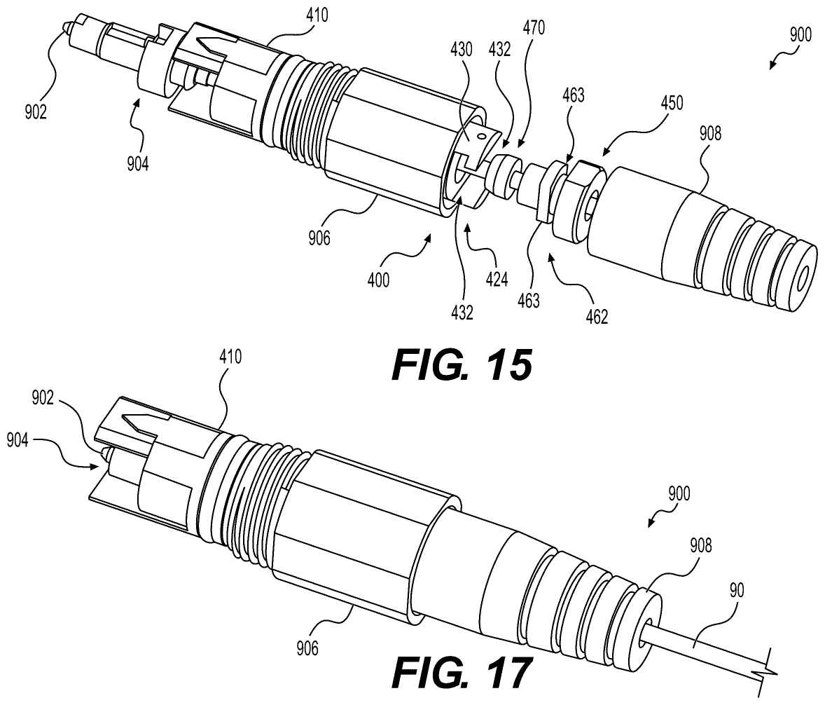

As best shown in FIGS. 14 and 15, the shroud 410 includes a first end or forward end 412 and a second end or rear end 414. The shroud 410 includes an opening 416 at the first end 412 to a first receiving portion or bore 418. The second end 414 of the shroud 410 includes a second receiving portion or bore 420. The second receiving portion 420 is configured to receive the grommet 470 therein, for example in an interference fit relationship or a loose fit relationship. The grommet 470 includes a receiving portion or through bore 476 configured to receive a fiber optic cable there through. The grommet 470 comprises a flexible structure that is configured to be compressed and to provide a biasing force against such compression. For example, the grommet 470 may be formed from a flexible material such as KRAYTON. The second end 414 of the shroud 410 includes a receiving portion or keyed portion 424, for example, on an outer surface 429 of the shroud 410.

The receiving portion 424 may include axially extending fingers 430, for example, diametrically opposed fingers, extending from the second end 414 of the shroud 410. In some aspects, the axially extending fingers 430 may include a lip 431 extending radially inward at the free end of the fingers 430. The fingers 430 are circumferentially spaced apart to define passages 432.

A middle portion 415 of the shroud 410 between the first end 412 and the second end 414 includes a third receiving portion or third bore 419 adjacent the first receiving portion 418 and having a smaller inside diameter than the first receiving portion 418 such that a forward facing surface 422 is defined at the transition from the first receiving portion 418 to the third receiving portion 419 and a tapered surface 425 is defined at the transition from the second receiving portion 420 to the third receiving portion 419. The grommet 470 includes a front end or forward end 471 having a tapered surface 472 configured to face the tapered surface 425. The grommet 470 includes a second end or rear end 477 having a rearward facing surface 478.

The boot 440 comprises first portion or forward portion 442 that is configured to be slidingly received in the first receiving portion 418 of the shroud 410. The first portion 442 of the boot 440 has an outside diameter that is greater than the inside diameter of the third receiving portion 419 such that the forward facing surface 422 of the shroud 410 acts as a stop that limits the distance that the boot 440 can be inserted into the shroud 410 via the opening 416. In some aspects, the first receiving portion 418 of the shroud 410 is configured to receive the first portion 442 of the boot 440 in an interference fit relationship. In other aspects, the first receiving portion 418 of the shroud 410 is configured to receive the first portion 442 of the boot 440 is a loose fit relationship. The boot 440 comprises a receiving portion or through bore 445 that is configured to slidingly receive a fiber optic cable 90 therethrough.

The nut 450 includes a receiving portion or through bore 452 configured to slidingly receive a fiber optic cable 90 therethrough, an engagement portion 454 for example, a cylindrical wall, that extends from a first end 456 of the nut 450 to a second end 460 of the nut 450, and a flange portion 458 at the second end of the nut 450. The nut 450 includes an engagement feature 462, for example, an annular flange, extending from the engagement portion 454 in a spaced apart relationship to the flange portion 458 and configured to be coupled with the receiving portion 424 of the shroud 410. The engagement feature 462 may comprise two diametrically opposed flattened regions 463.

The engagement feature 462 is configured to be slidingly received through the passages 432 of the receiving portion 424 so that the engagement feature 462, for example, the flattened regions 463, extends beyond the receiving portion 424 and can be rotated relative to the receiving portion 424. When the nut 450 is rotated relative to the shroud 410, for example, by about 90°, or a quarter turn, the receiving portion 424 is configured to engage the engagement feature 462 to prevent the nut 450 from being biased away from the shroud 410 by the compressed grommet 470, as will be discussed in more detail below.

Referring to FIG. 15, to provide a weathertight sealed connection between the grommet 470 and a fiber optic cable 90 received by the grommet 470, the nut 450 is moved relative to the shroud 410 such that the engagement portion 454 moves axially into the receiving portion 424 of the shroud 410. As the nut 450 is moved further axially relative to the shroud 410, the engagement feature 462 of the nut 450 is inserted through the passages 432 of the receiving portion 424 of the shroud 410 until the engagement feature 462, for example, the annular projection, extends beyond the receiving portion 424. As engagement feature 462 of the nut 450 is inserted through the passages 432 of the receiving portion 424, the forward facing surface 466 at the first end 456 of the nut 450 engages the rearward facing surface 478 of the grommet 470 and is configured to compress, for example, axially compress, the grommet 470 against the tapered surface 425 of the shroud 410 such that the grommet 470 is compressed into the third receiving portion 419 of the shroud 410 via the tapered surface 425 and is radially compressed onto the fiber optic cable 90 and against an tapered surface 425 of the shroud 400.

When the engagement feature 462, for example, the annular projection, extends beyond the receiving portion 424, the nut 450 is rotated relative to the shroud 410, for example, by about 90°, or a quarter turn, until the engagement feature 462 is aligned with the receiving portion 424 such that the receiving portion 424 is configured to engage the engagement feature 462 to prevent the nut 450 from being biased away from the shroud 410 by the compressed grommet 470.

The flange portion 458 of the nut 450 may include a knurled outer surface to facilitate hand tightening (i.e., without the use of a tool) of the nut 450 to the shroud 410. In some aspects, the flange portion 458 of the nut 450 may comprise a hexagonal surface to facilitate hand tightening while also accommodating tightening via a tool, for example, a wrench.

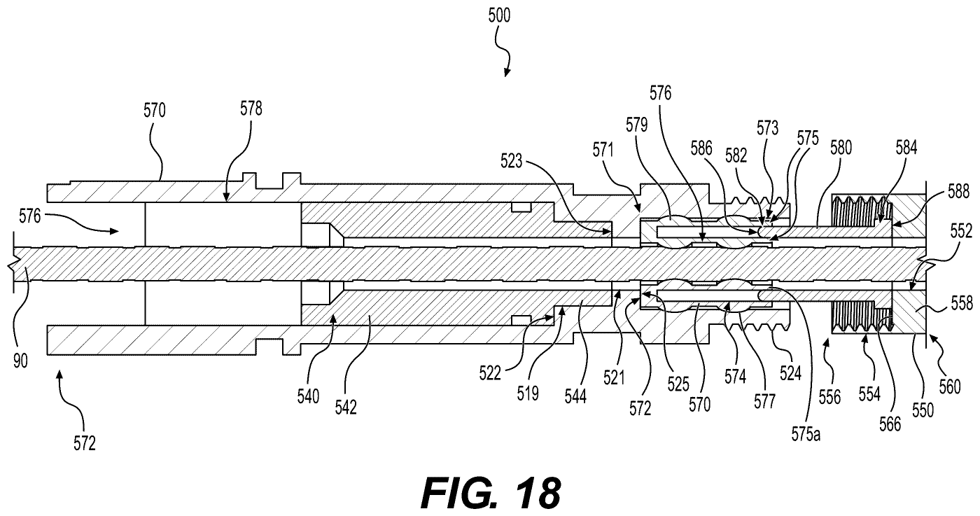

FIGS. 18-20 illustrate a fifth embodiment of an exemplary seal assembly 500 for a hardened fiber optic connector (HFOC) in accordance with various aspects of the disclosure. As shown in FIGS. 18-20, the seal assembly 500 includes a shroud or shroud portion 510 (also referred to as a shell or housing) of a hardened fiber optic connector, a resilient member or boot 540 of the hardened fiber optic connector, a coupler or tightening portion or nut 550, a biasing member or sealing portion or grommet 570, and an engagement member 580. Additional features of an exemplary hardened fiber optic connector that incorporates the seal assembly 500 are described above in connection with FIGS. 11-17.

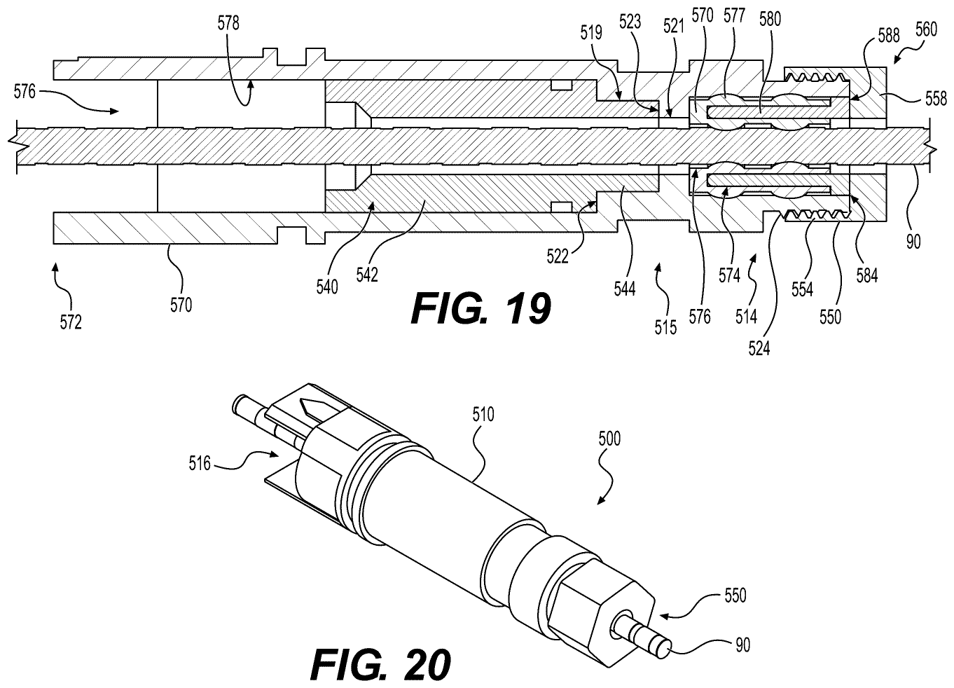

As best shown in FIGS. 18 and 19, the shroud 510 includes a first end or forward end 512 and a second end or rear end 514. The shroud 510 includes an opening 516 at the first end 512 to a first receiving portion or bore 518. The second end 514 of the shroud 510 includes a second receiving portion or bore 520. The second receiving portion 520 is configured to receive the grommet 570 therein, for example in an interference fit relationship or a loose fit relationship. The grommet 570 includes a receiving portion or through bore 576 configured to receive a fiber optic cable there through. The grommet 570 comprises a flexible structure that is configured to be compressed and to provide a biasing force against such compression. For example, the grommet 570 may be formed from a flexible material such as KRAYTON. The second end 514 of the shroud 510 includes a receiving portion or threaded portion 524, for example, on an outer surface 529 of the shroud 510.

A middle portion 515 of the shroud 510 between the first end 512 and the second end 514 includes a third receiving portion or third bore 519 adjacent the first receiving portion 518 and having a smaller inside diameter than the first receiving portion 518 such that a forward facing surface 522 is defined at the transition from the first receiving portion 518 to the third receiving portion 519. The middle portion 515 further includes a fourth receiving portion 521 having a smaller inside diameter than the third receiving portion 519 and the second receiving portion 520 such that a forward facing surface 523 is defined at the transition from the third receiving portion 519 to the fourth receiving portion 521 and a rearward facing surface 525 is defined at the transition from the second receiving portion 520 to the fourth receiving portion 521.

The boot 540 comprises a first portion or forward portion 542 that is configured to be slidingly received in the first receiving portion 518 of the shroud 510 and a second portion or rear portion 544 that is configured to be received in the third receiving portion 519 of the shroud 510. The first portion 542 of the boot 540 has an outside diameter that is greater than the inside diameter of the third receiving portion 519, and the second portion 544 of the boot 540 has an outside diameter that is greater than the inside diameter of the fourth receiving portion 521, such that the forward facing surface 522 of the shroud 510 and/or the forward facing surface 523 of the shroud 510 acts as a stop that limits the distance that the boot 540 can be inserted into the shroud 510 via the opening 516. In some aspects, the first receiving portion 518 of the shroud 510 is configured to receive the first portion 542 of the boot 540 in an interference fit relationship. In other aspects, the first receiving portion 518 of the shroud 510 is configured to receive the first portion 542 of the boot 540 in a loose fit relationship. In some aspects, the third receiving portion 519 of the shroud 510 is configured to receive the second portion 544 of the boot 540 in an interference fit relationship. In other aspects, the third receiving portion 519 of the shroud 510 is configured to receive the second portion 544 of the boot 540 in a loose fit relationship. The boot 540 comprises a receiving portion or through bore 545 that is configured to slidingly receive a fiber optic cable 90 therethrough.

The nut 550 includes a receiving portion or through bore 552 configured to slidingly receive a fiber optic cable 90 therethrough, a threaded portion 554, for example, an internal threaded surface, that extends from a first end 556 of the nut 550 to a second end 560 of the nut 550, and a flange portion 558 at the second end of the nut that comprises a forward facing surface 566.

In some aspects, the engagement member 580 may comprise, for example, a cylindrical wall, that extends from a first end 582 of the engagement member 580 to a second end 584 of the engagement member 580. The engagement member 580 includes a forward facing surface 586 at the first end 582 and a rearward facing surface 588 at the second end 584. The second end 584 may comprise a flange portion that defines the rearward facing surface 588.

The grommet 570 includes a first end or forward end 571 having a forward facing surface 572 configured to face the rearward facing surface 525 of the shroud 510 and a second end or rear end 573. The grommet 570 includes a receiving portion 574, for example, an annular opening, between a pair of spaced apart structures 575, for example, concentric cylindrical walls that are spaced apart in a radial direction. The through bore 576 extends through the inner one 575a of the spaced apart walls 575. The receiving portion 574 is closed at the first end 571 of the grommet 570. The receiving portion 574 comprises a radial length that is less than a radial length of the engagement member 580. The grommet 570 includes an enlarged portion or annular projection 577 that extends radially outward from an outer surface 578 of the grommet 570 and radially inward from an inner surface 579 of the grommet 570.

Referring to FIG. 19, to provide a weathertight sealed connection between the grommet 570 and a fiber optic cable 90 received by the grommet 570, the first end of the engagement member 580 is inserted into the receiving portion 574 of the grommet 570, and the nut 550 is threadedly coupled with the shroud 510. For example, the threaded portion 554 of the nut 550 is coupled with the threaded portion 524 of the shroud 510. As the nut 550 is threadedly coupled with the shroud 510, the forward facing surface 566 of the nut 550 engages the rearward facing surface 588 of the engagement member 580. As the nut 550 is threaded further onto the shroud 510, the forward facing surface 566 of the nut 550 is configured to urge the engagement member 580 axially further into the receiving portion 574 of the grommet 570. Because the receiving portion 574 comprises a radial length that is less than a radial length of the engagement member 580, when the engagement member 580 is inserted into the receiving portion 574, the engagement member 580 urges the receiving portion 574 radially inward and radially outward such that the enlarged portion 577 of the grommet 570 sealingly engages an outer surface of the fiber optic cable 90 and an inner surface of the second receiving portion 520 of the shroud 510.

The flange portion 558 of the nut 550 may include a hexagonal outer surface to facilitate hand tightening while also accommodating tightening via a tool, for example, a wrench. In some aspects, the flange portion 558 of the nut 550 may comprise a knurled outer surface to facilitate hand tightening (i.e., without the use of a tool) of the nut 550 to shroud 510.

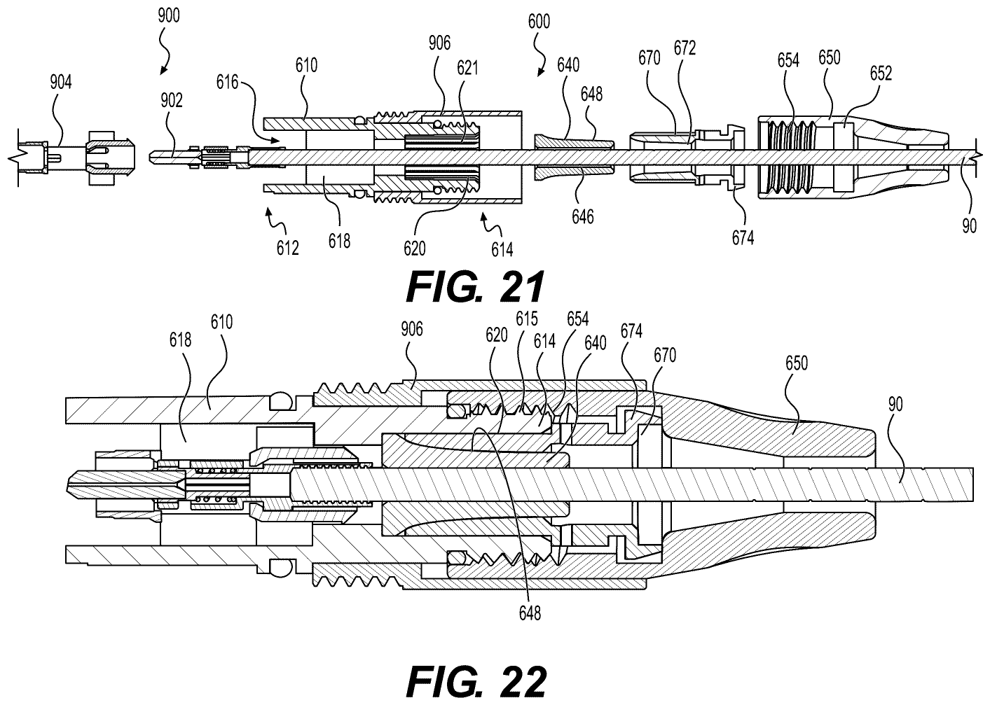

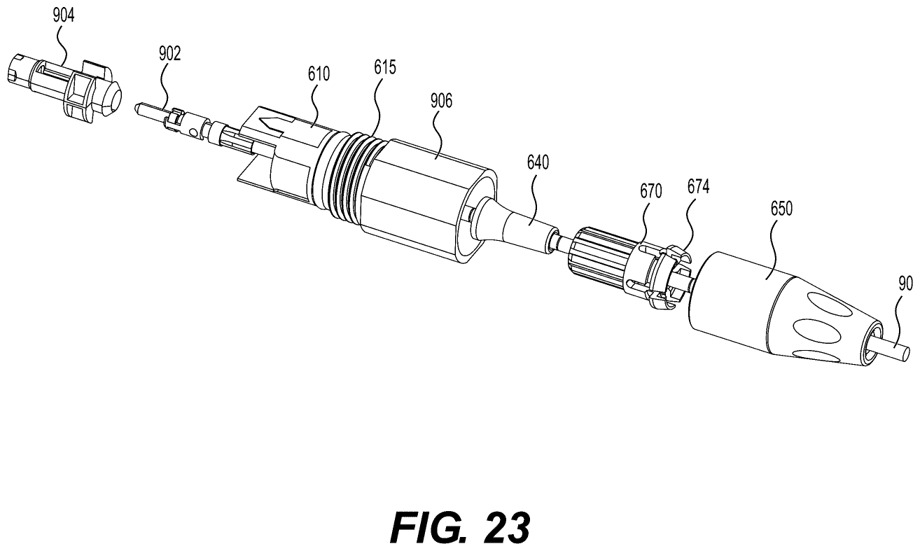

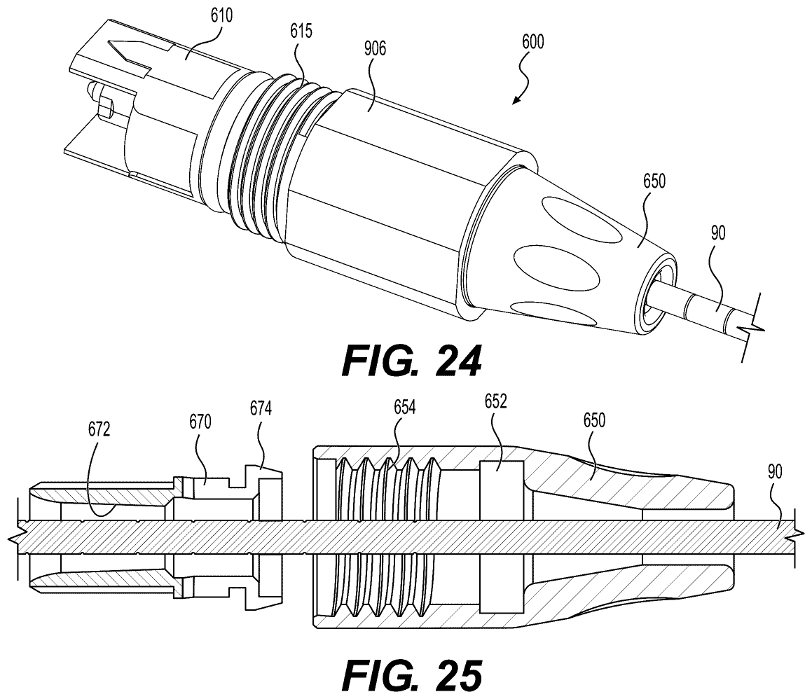

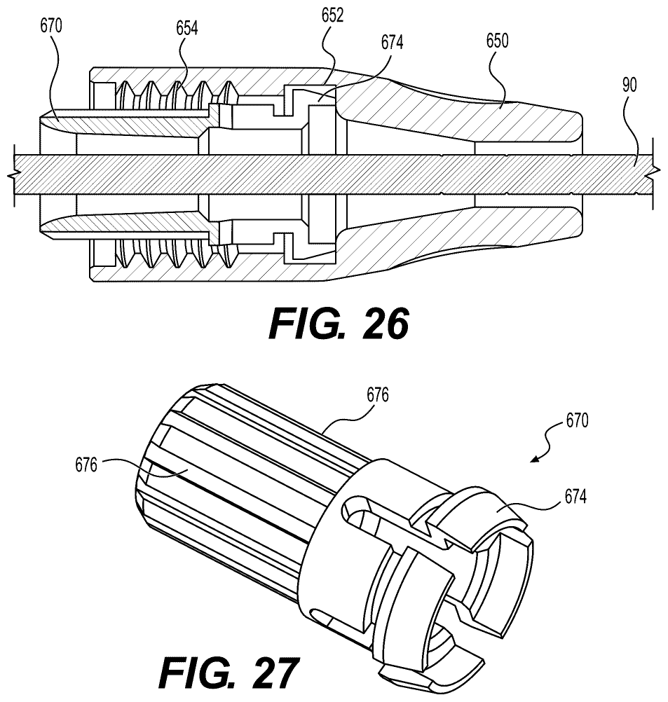

FIGS. 21-27 illustrate a sixth embodiment of an exemplary seal assembly 600 for a hardened fiber optic connector (HFOC) in accordance with various aspects of the disclosure. As shown in FIGS. 21 and 22, the seal assembly 600 includes a shroud or shroud portion 610 (also referred to as a shroud, shell or housing) of a hardened fiber optic connector 900, a resilient member or sealing portion or grommet 640, a coupler or tightening portion or back nut or nut 650, and a biasing member or pusher or pusher portion 670.

The exemplary hardened fiber optic connector 900 includes a ferrule 902 that is configured to terminate a fiber of a fiber optic cable 90, a carrier or holder 904 that is configured to receive the ferrule 902 and that is configured to be received in the shroud 610, an outer housing or shell 906 that is configured to receive the shroud 610 and that is configured to be coupled with an HFOC receptacle.

As best shown in FIGS. 21 and 22, the shroud 610 includes a first end or forward end 612 and a second end or rear end 614. The shroud 610 includes an opening 616 at the first end 612 to a first receiving portion or bore 618. The second end 614 of the shroud 610 includes a second receiving portion or bore 620. The second receiving portion 620 is configured to receive the grommet 640 therein, for example in an interference fit relationship or a loose fit relationship. The grommet 640 includes a receiving portion or through bore 646 configured to receive a fiber optic cable 90 there through. The grommet 640 comprises a flexible structure that is configured to be compressed and to provide a biasing force against such compression. For example, the grommet 640 may be formed from a flexible material such as KRAYTON.

In embodiments, the assembly is assembled as follows. The ferrule 902 is fed through the back nut 650, the pusher 670, the grommet 640, the lock slide 906, and the shroud 610. The carrier 904 is then pushed onto, and engages, the ferrule 902. The grommet 640 is then inserted into the second receiving portion 620 of the shroud 610. The pusher 670 has a receiving portion 672 that is configured to receive the grommet 640. In embodiments, the receiving portion 672 has an angled wall (for example, such as a truncated cone) that is configured to receive an angled wall 648 of the grommet 640. The pusher is then pressed onto the grommet 640 such that the grommet 640 is located partially in the receiving area 672. The pusher 670 is pressed into the back nut 650 to the point where a pusher engagement portion 674 engages a pusher receiving portion 652 of the back nut 650. The pusher 670 can be pressed into the back nut 650 either before or after the pusher 670 is pressed onto the grommet 640. The back nut 650 is provided with internal threads 654 that are configured to engage external threads 615 provided on the shroud 610. The back nut 650 is threaded onto the shroud 610 to secure the various parts of the assembly, as shown in FIG. 22.

FIG. 21 shows the through bore 646 of the grommet 640 as being larger that the fiber optic cable 90 to facilitate assembly. The tightening of the back nut 650 onto the shroud 610 causes the angled wall of the receiving portion 672 of the pusher 670 to press against the angled wall 648 of the grommet 640. The pressing causes the grommet to deform radially inward such that the through bore 646 of the grommet 640 tightens around the fiber optic cable 90, as shown in FIG. 22, creating a seal between the grommet 640 and the fiber optic cable 90. The tight fit between the grommet 640 and the fiber optic cable 90 also provides strain relief by securing the fiber optic cable 90 to the assembly.

FIG. 27 shows an engagement portion such as, for example, one or more ribs 676 on an outer surface of the pusher 670. The ribs 670 engage a receiving portion such as, for example, one or more grooves 621 on an inner surface of the bore 620 of the shroud 610 to prevent the pusher 670 from rotating relative to the shroud 610. It may be advantageous to prevent rotation of the pusher 670 relative to the shroud 610 so as to provide only axial movement of the pusher 670 relative to the grommet 640 during assembly and tightening so as to prevent twisting deformation of the grommet 640.

The foregoing description of exemplary embodiments provides illustration and description but is not intended to be exhaustive or to limit the embodiments described herein to the precise form disclosed. Modifications and variations are possible in light of the above teachings or may be acquired from practice of the embodiments.

Although the invention has been described in detail above, it is expressly understood that it will be apparent to persons skilled in the relevant art that the invention may be modified without departing from the spirit of the invention. Various changes of form, design, or arrangement may be made to the invention without departing from the spirit and scope of the invention. Therefore, the above mentioned description is to be considered exemplary, rather than limiting, and the true scope of the invention is that defined in the following claims.

What is claimed is:

1. A seal assembly for a field installable hardened fiber optic connector structurally configured to provide improved sealing and strain relief with a fiber optic cable comprising:
a shroud structurally configured to receive a terminated end of a fiber optic cable;
a nut structurally configured to be coupled with an end of the shroud;
a pusher structurally configured to be received by the nut and the shroud;
a sealing portion structurally configured to be received by the pusher and the shroud;
wherein the nut is structurally configured to include an engaging portion that is structurally configured to engage the pusher such that the pusher is coupled to the nut;
wherein the pusher is structurally configured to engage the shroud;
wherein the engagement of the pusher with the shroud limits rotation of the pusher relative to the shroud;
wherein the nut comprises a single piece monolithic construction that includes the engagement portion;
wherein the nut is structurally configured to threadedly engage the shroud such that tightening of the nut compresses the sealing portion onto a fiber optic cable received in the shroud to form a seal around the fiber optic cable and resist axial movement of the fiber optic cable relative to the sealing portion so as to provide enhanced weathertight sealing and strain relief between the shroud and the fiber optic cable.

2. The seal assembly of claim 1, wherein the engagement portion comprises a structure that is separate from a remainder of the nut.

3. The seal assembly of claim 1, wherein the engagement portion is structurally configured to be received in the pusher.

4. The seal assembly of claim 1, wherein the sealing portion is structurally configured to deform in response to movement of the nut relative to the shroud.

5. The seal assembly of claim 1, wherein the sealing portion is structurally configured to have different radial cross-sections along an axial direction of the sealing portion.

6. The seal assembly of claim 1, wherein a first end of the sealing portion that is received by the pusher has a smaller radial diameter and a second end of the sealing portion that is receive by the shroud.

7. The seal assembly of claim 1, wherein the sealing portion is a grommet.

8. A hardened fiber optic connector comprising:
the seal assembly of claim 1;
a ferrule structurally configured to terminate a fiber of the fiber optic cable;
a holder structurally configured to receive the ferrule and to be received in the shroud; and
a shell structurally configured to receive the shroud and to be coupled with a hardened fiber optic connector receptacle.

9. The hardened fiber optic connector of claim 8, further comprising an outer boot structurally configured to be coupled with the shroud and/or the shell.

10. A seal assembly for a field installable hardened fiber optic connector structurally configured to provide improved sealing and strain relief with a fiber optic cable comprising:
a shroud portion structurally configured to receive a fiber optic cable;
a tightening portion structurally configured to be coupled with the shroud portion;
a pusher portion structurally configured to transfer movement of the tightening portion;
a sealing portion structurally configured to receive the transferred movement of the pusher portion;
wherein an engagement of the pusher portion with the shroud portion limits rotation of the pusher portion relative to the shroud portion; and
wherein the tightening portion is structurally configured to threadedly engage the shroud such that tightening of the tightening portion compresses the sealing portion onto a fiber optic cable received in the shroud to form a seal around the fiber optic cable and resist axial movement of the fiber optic cable relative to the sealing portion so as to provide enhanced weathertight sealing and strain relief between the shroud and the fiber optic cable.

11. The seal assembly of claim 10, wherein the tightening portion is structurally configured to be coupled with an end of the shroud portion.

12. The seal assembly of claim 10, wherein the pusher portion is structurally configured to be received by the tightening portion and the shroud portion.

13. The seal assembly of claim 10, wherein the sealing portion is structurally configured to be received by the pusher portion and the shroud portion.

14. The seal assembly of claim 10, wherein the tightening portion is structurally configured to include an engaging portion that is structurally configured to engage the pusher portion such that the pusher portion is coupled to the tightening portion.

15. The seal assembly of claim 14, wherein the tightening portion comprises a single piece monolithic construction that includes the engagement portion.

16. The seal assembly of claim 10, wherein the tightening portion is structurally configured to threadedly engage the shroud portion.

17. The seal assembly of claim 10, wherein the compression of the sealing portion on the fiber optic cable resists axial movement of the fiber optic cable relative to the sealing portion.

18. A seal assembly for a field installable hardened fiber optic connector structurally configured to provide improved sealing and strain relief with a fiber optic cable comprising:
a pusher portion structurally configured to transfer movement of a tightening portion;
a sealing portion structurally configured to receive the transferred movement of the pusher portion;
wherein an engagement of the pusher portion with a shroud portion limits rotation of the pusher portion relative to the shroud portion;
wherein the sealing portion structurally configured to compress to form a seal around the fiber optic cable; and
wherein tightening of a tightening portion compresses the sealing portion onto a fiber optic cable to form a seal around the fiber optic cable and resist axial movement of the fiber optic cable relative to the sealing portion so as to provide enhanced weathertight sealing and strain relief between a shroud and the fiber optic cable.

19. The seal assembly of claim 18, further comprising a shroud portion that is structurally configured to receive the fiber optic cable.

20. The seal assembly of claim 19, further comprising a tightening portion that is structurally configured to be coupled with the shroud portion.

21. The seal assembly of claim 20, wherein an engagement of the tightening portion with the shroud portion is structurally configured to compress the sealing portion to form the seal around the fiber optic cable.

22. The seal assembly of claim 20, wherein the tightening portion is structurally configured to be coupled with an end of the shroud portion.

23. The seal assembly of claim 20, wherein the pusher portion is structurally configured to be received by the tightening portion and the shroud portion.
